(19) United States
(12) Patent Application Publication
(10) Pub. No.: US 2020/0391141 A1
(43) Pub. Date: Dec. 17, 2020

(54) FILTER

(71) Applicant: Oliver SPIES, Berlin (DE)

(72) Inventor: Oliver SPIES, Berlin (DE)

(21) Appl. No.: 17/004,638

(22) Filed: Aug. 27, 2020

Related U.S. Application Data
(63) Continuation of application No. PCT/EP2019/052496, filed on Feb. 1, 2019.

(30) Foreign Application Priority Data
Feb. 28, 2018 (DE) 10 2018 104 535.2

(51) Int. Cl. B01D 29/27; B01D 39/08; C02F 1/00; A47L 13/50

(52) U.S. Cl. CPC B01D 29/27; B01D 39/083; C02F 1/001; C02F 2101/30; B01D 2201/02; B01D 2239/1216; A47L 13/50

(57) ABSTRACT

A filter is provided for filtering dirty water. The filter has an inlet opening for the dirty water, which inlet opening is at the top during normal use of the filter, and a filter element, by which the water passing through the filter is filtered. The filter element is designed to retain microplastic particles or microplastic fibers having diameters or lengths of 200 μm and the filter has a holding structure, by which the filter can be fastened to the upper edge of a bucket corresponding thereto in the dimensions of the bucket, in such a way that the filter, hanging on the outside of the bucket, can be used as a pouring filter for filtering the dirty water running out of the bucket when the bucket is tipped.

### CROSS REFERENCE TO RELATED APPLICATIONS

This application is a continuation under 35 U.S.C. § 120 of International Application PCT/EP2019/052496, filed Feb. 1, 2019, which claims priority to German Application No. 10 2018 104 535.2, filed Feb. 28, 2018, the contents of each of which are incorporated by reference herein.

### FIELD OF THE INVENTION

The present invention relates to a filter for filtering dirty water, with an inlet opening for the dirty water, provided on the upper side for use of the filter as intended, and with a filter element, by which the water passing through the filter is filtered.

### BACKGROUND

Many of the textiles and clothing items sold nowadays, especially outdoor wear or other functional garments consisting of synthetic fibers, consist of plastic fibers in a not unsubstantial proportion. These textiles have the disadvantage that plastic fibers or fragments of plastic fibers are washed or dissolved out, especially while they are being laundered, and are then released together with the wastewater into the environment. Since such plastic fibers are quite generally very small and short fibers or fiber fragments, conventional wastewater filters of washing machines or other filters used heretofore in the home for filtering dirty water are not capable of holding back the said fibers to a noteworthy extent. Sewage treatment plants are certainly able to hold back a certain proportion of the plastic fibers found in wastewater, but as in the past they still pass a large part of such fibers, which therefore contribute in a not inconsiderable extent to contamination of rivers and oceans, where they ultimately end up in the food chain again via the food intake of animals. Obviously it is desirable that washing machines, sewage treatment plants, etc. be equipped with suitable microplastic filters, but obviously this is not yet comprehensively possible.

In this connection, a laundry bag to be used in connection with laundering textiles containing plastic fibers is already known from WO 2017/121862 A1, which bag functions as a means for holding back plastic fibers or fiber fragments washed out of the textiles and thus is able to contribute to environmental protection.

It is also to be assumed, however, that fibers or fiber fragments are leached out of textiles containing plastic fibers during use thereof, and so for this reason, extremely many plastic particles and fibers are also swirled around in the ambient air and settle on surfaces of all kinds, from which they are wiped off during cleaning and ultimately are disposed of in the wastewater. Further sources for environmental contamination are plastic particles, which are released by abrasion from tires and shoe soles and may likewise reach the environment together with dirty water.

### SUMMARY

Against this background, it is intended with the present invention to provide a further possible resource for environmental protection that can be used as practically and universally as possible.

For this purpose, the present invention may relate to a filter of the type mentioned in the introduction for filtering dirty water, which filter is characterized in that the filter element is designed for holding back microplastic particles with diameters or lengths of 200 μm and in that the filter has a holding structure, with which it can be fastened to the upper rim of a bucket having dimensions corresponding to it in such a way that the filter, hanging on the outside of the bucket, is able to function as a pouring filter for filtering the dirty water running out of the bucket when the bucket is being tipped.

By the fact that the filter is very simply constructed and has a holding structure with which it can be fastened or braced on a bucket corresponding in its dimensions to the filter, it proves to be a resource that can be used particularly easily—especially in the home—wherein the dirty water is filtered during passage (gravity-induced) through the filter element contained in the filter.

The particles collecting in the filter can be easily removed after use thereof and then sent to professional disposal.

In a first configuration of the present invention, the filter may have a holding structure comprising two retaining brackets, with which it can be hung in the claimed sense on the upper rim of a bucket having dimensions corresponding to it, in such a way that the filter, hanging on the outside of the bucket, is able to function as a pouring filter for filtering the dirty water running out of the bucket when the bucket is being tipped.

Thus a resource that is particularly simple and practical to use for cleaning purposes is provided for environmental protection.

In this connection, it may be preferably provided that the filter can be hung in the manner of a pendulum on the upper rim of a bucket by appropriate configuration of the holding structure, so that, when the bucket is being tipped, the filter is able to swing, under its own weight and/or under the additional weight of the water running out of the bucket into the filter, away from the bucket in such a way that, despite the tipping of the bucket, it at least largely retains its spatial orientation imposed (with typically an inlet opening disposed in an approximately horizontal plane) when the bucket is standing upright.

A holding structure that permits such pendulum-type suspension has in particular the advantage that the filter is then also available with its entire volume and thus does not overflow easily even when the bucket is being tipped, and this independently of the actual tipping angle.

Advantageously, at least one stop element (advantageously even two stop elements disposed on different sides of the filter) are provided on the filter that can be used in such a way on a bucket, which elements, in cooperation with an outwardly projecting bucket rim on the bucket, prevent slipping of the filter when the bucket is being tipped.

In the case of such a filter functioning as pouring filter for a bucket, the filter element may advantageously overlay at least one cutout in at least one wall bounding the interior space of the filter.

In yet another preferred configuration of an inventive filter, it may be provided that the holding structure of the filter is formed by at least one (flexible) fastening tape, with which the filter can be fastened in the region of the upper bucket rim, in particular by the fact that the at least one fastening tape on the upper bucket rim encircles it and is suitably fixed there. Such a filter having at least one fastening tape (which is flexible and if necessary is even of elastic construction) can be made particularly simply as the holding structure and can be fixed on the bucket in simple manner. Advantageously, two such fastening tapes (for example, positioned on different sides of the actual filter) may be provided, which tapes can be appropriately joined to one another in the region of their free ends for fastening the filter on the upper bucket rim.

Furthermore, it may be preferably provided that the at least one fastening tape has a hook-and-loop fastener. In the case of use of two fastening tapes (which are able to encircle the left and right side of the upper bucket rim), then one part of this hook-and-loop fastener may be provided on each of the two fastening tapes respectively.

It is further of particular advantage when the at least one fastening tape and/or the hook-and-loop fastener is disposed and/or dimensioned in such a way that the filter is suitable, within given limits, for fastening on buckets of various sizes (meaning, for example, on buckets with differently large circumferences in the region of their upper rim) and/or on buckets with different cross-sectional geometry (e.g. oval or rectangular buckets).

In yet another preferred configuration of an inventive filter, the filter may have a filter bag equipped with the inlet opening for the water to be filtered. This filter configuration is suitable in particular for filters that, as described in the foregoing, can be fastened or hung on the upper bucket rim by means of a fastening tape functioning as a holding structure.

Such a filter bag may advantageously be made from two layers (of any appropriate material, if necessary comprising multiple layers) joined to one another peripherally, especially stitched to one another by means of reinforcing tapes, of which at least one first layer functions at least in some regions as a filter element.

Furthermore, as will be explained further in still more detail on the basis of an exemplary embodiment of the invention, it is of advantage when the filter bag has, in the region of the inlet opening, on two opposite sides, a notch, which is V-shaped or can be spread apart in V-shaped manner, into which notch the bucket rim is able to penetrate when the filter is fastened as intended on a bucket. The peripheral portion of the filter bag, which in this case is disposed underneath the bucket rim, is then able to bear tightly on the outer surface of the bucket when the filter is fastened as intended, while an oppositely disposed peripheral portion of the filter bag projects beyond the bucket rim, so that, when the bucket is tipped, the dirty water contained in the bucket is able to penetrate without loss through the inlet opening and into the filter bag and then exit this again in filtered condition under the effect of gravity. The dirt particles, including microplastic impurities, held back in the filter bag can then be removed from the filter bag and disposed of professionally.

All rim regions of the filter bag may advantageously be reinforced with reinforcing tapes.

In the case of a filter with filter bag and notches that are V-shaped (or can be spread apart in V-shaped manner) in the region of the inlet opening, it proves to be particularly expedient when two fastening tapes are provided, each of which is branched into a first and second fastening tape portion, wherein the two fastening tape portions of each fastening tape are positioned on different limbs of the V-shaped notch of the filter bag. Thus it can be ensured with the fastening tapes that both the rim portion of the filter bag bearing on the outside of the bucket underneath the bucket rim and the rim portion of the filter bag extending upward beyond the bucket rim are held firmly on both sides and can be fastened securely on the bucket.

Incidentally, in this connection, the two branched fastening tape portions of each fastening tape can or should advantageously have different lengths, so that the inlet opening of the filter bag may be appropriately widened (by the hydraulic pressure exerted by the water) when the bucket is being tipped.

Particularly advantageously, the entire filter including filter element and holding structure (and also including any reinforcing tapes or walls if present, the yarn used for stitching and any hook-and-loop fastener if present) may be made from a single material, especially from a polyamide, especially from polyamide 6.6. In this case, especially the entire filter can be simply recycled in environmentally safe manner after the end of its useful life.

For all filter variants discussed in the foregoing, it may be provided that the filter element is formed by a filter fabric, especially a plastic screen fabric, having a mean mesh width of 5 μm-200 μm, preferably of 20-100 μm or of 20-80 μm. A filter bag as described in the foregoing may advantageously be made as a large-area product from such a filter fabric, if necessary with peripheral reinforcing tapes of the same or different material.

For the plastic screen fabric, it is preferable to resort to a thermoset polyamide, especially polyamide 6.6 (PA 6.6). Hereby it is possible in particular to achieve a continuous temperature resistance of 100° C. (wet), which is most suitable for the present purpose. Obviously it is also possible, however, within the scope of the present invention, to use other materials, provided they are sufficiently stable under the usual environmental conditions.

Furthermore, the use of a monofilament fabric, which incidentally can be used in a single layer, is of advantage. It has proved particularly suitable for the present invention to use a single-layer, monofilament screen fabric of PA 6.6 with a fabric thickness of approximately 80 μm, a (mean) mesh width of warp and weft of respectively 50 μm with a tolerance of only +/−10% and an open screen area of 27%.

Finally, the present invention further relates to a kit comprising a bucket and a filter of the inventive type fixed thereon.

### BRIEF DESCRIPTION OF THE DRAWING

The present invention will be explained in more detail hereinafter on the basis of the drawing, wherein

FIGS. 1-6 show a first exemplary embodiment of an inventive filter with a holding structure, which can be fastened as a pouring filter on a bucket, and

FIGS. 7-10 show a second exemplary embodiment of an inventive filter, in some cases in the kit with a bucket, in photorealistic and schematic representation.

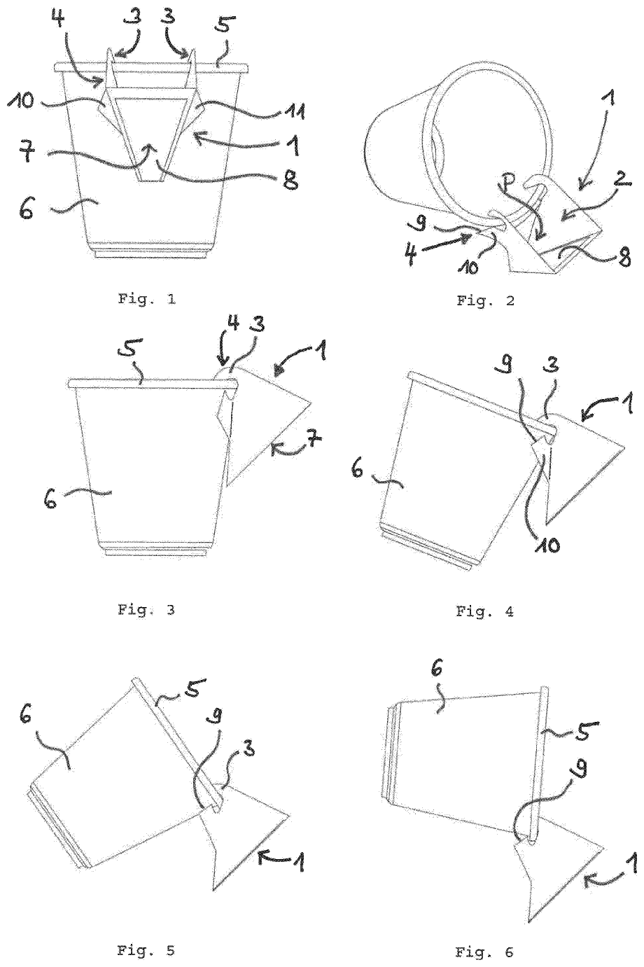

### DETAILED DESCRIPTION OF THE PREFERRED EMBODIMENTS

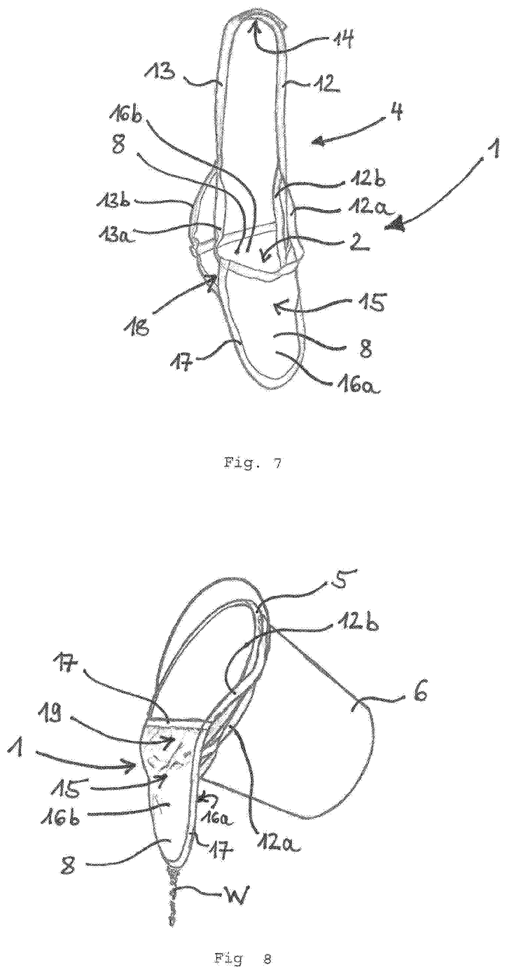

FIGS. 16 show, in various perspectives and in various orientations, a first exemplary embodiment of an inventive filter 1 with an inlet opening 2 provided at the upper side of filter 1 for dirty water to be filtered, which filter has a holding structure 4 having (preferably) two holding brackets 3, with which filter 1 can be fastened or braced on the upper rim 5 of a (suitably dimensioned) bucket 6. In this filter 1, which functions as a pouring filter for dirty water to be emptied from bucket 6, inlet opening 2 is of rectangular shape. The water running out of tipped bucket 6 according to arrow P of FIG. 2 enters filter 1 through upper inlet opening 2 and runs out of the filter once again through filter element 8 provided in a side face 7 extending to the lower periphery of filter 1.

Filter 1 may consist of a thin-walled material, e.g. plastic, wherein filter element 8 consisting of a filter fabric with suitable small meshes is provided in a cutout of the side 7 of filter 1 facing away from bucket 6. In the present case, filter element 8 is formed by a large-area filter fabric of a thermoset plastic (screen) fabric of polyamide 6.6 having a mean mesh width of, for example, 50 μm.

FIGS. 3-6, showing a side view of bucket 6 with filter 1 suspended on its upper rim 5, illustrate that the given holding structure 4 is created in such a way that filter 1 is fastened in the manner of a pendulum on bucket 6, so that filter 1 occupies a substantially constant orientation in space regardless of the respective tipped position of bucket 6. The stops 9 provided on filter 1 underneath holding brackets 3 reliably prevent slipping of filter 1 from bucket 6, by the fact that they become stopped against the leading rim 5 of bucket 6 when bucket 6 is being tipped at a large inclination.

Two wing portions 10, 11 of a flexible material, provided on filter 1 at the left and right sides, bearing on bucket 6 with preload when bucket 6 is standing upright and also forming stop elements 9, ensure that the free spacing between holding brackets 3 and stop elements 9 decreases when filter 1 swivels due to its pendulum-type suspension when bucket 6 is being tipped. Hereby filter 1 is always held reliably on bucket 6. By pulling wing portions 10, 11 laterally apart, the spacing between them and holding brackets 15 is increased, wherewith filter 12 may be easily removed from bucket 14.

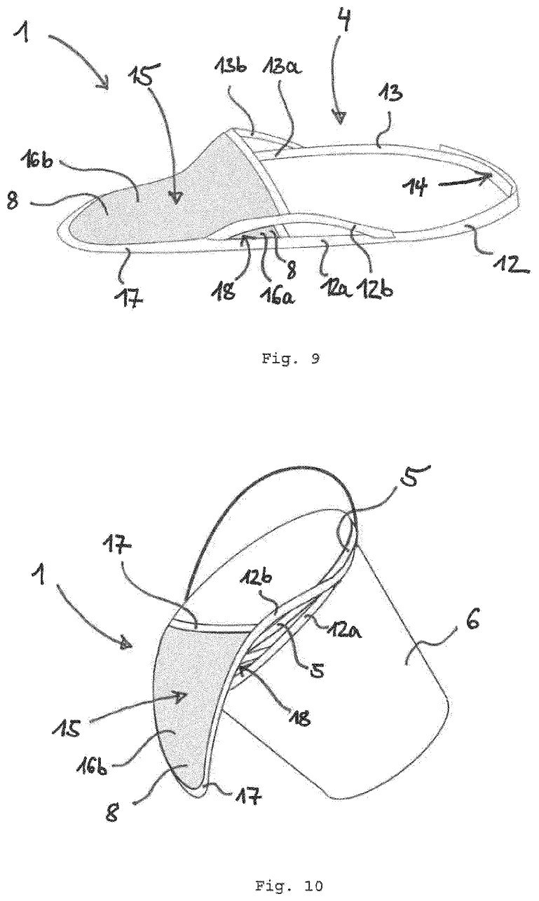

Finally, FIGS. 7-10 further illustrate in photorealistic (FIGS. 7 and 8) and schematic (FIGS. 9 and 10) representation a second exemplary embodiment of an inventive filter 1, which can be hung or fastened on upper rim 5 of a bucket 6 having dimensions corresponding to it in such a way that, while hanging on the outside of bucket 6 (see FIGS. 8 and 10), it functions in the inventive sense as a pouring filter for filtering the dirty water running out of bucket 5 when bucket 6 is tipped.

As holding structure 4, this filter 1 has two fastening tapes 12, 13 which, for fastening of filter 1 on bucket 6 in its upper or uppermost rim region, can be guided on the left and right sides (typically directly underneath a rim 5 projecting outwardly from bucket 6) around bucket 6 and in the region of their free ends can be joined to one another by means of a hook-and-loop fastener 14 on the side of the bucket opposite filter 1. If the two fastening tapes 12, 13 are joined with light tension, fastening of filter 1 on bucket 6 that is sufficiently stable for the desired purpose can be achieved.

Furthermore, filter 1 illustrated in FIGS. 7-10 has a filter bag 15 in which the water to be filtered is able to flow through an inlet opening 2. In the given example, filter bag 15 is made from two layers 16a, 16b of a filter fabric functioning as a large-area filter element 8, wherein the two layers 16a, 16b bounding filter bag 15 on different sides are respectively reinforced in their peripheral region with a reinforcing tape 17.

The two layers 16a, 16b of filter fabric are suitable in the inventive sense for holding back microplastic particles or fibers with lengths/diameters of approximately 200 μm. For this purpose, they may be made, for example, from the materials already mentioned hereinabove and are joined or stitched to one another peripherally in the region of the (respective) reinforcing tape 17.

In this case, the stitching yarn, the reinforcing tapes 17, the fastening tapes 12, 13—constructed in the given example as one-piece continuations of the reinforcing tapes 17—as well as the hook-and-loop fastener 14 may be made of the same material as the filter fabric.

In FIGS. 7 and 9, it can be clearly recognized that filter bag 15 has a notch 18 that is V-shaped or can be spread apart in V-shaped manner in the region of inlet opening 2 on two opposite sides, so that, in the region of the notches 18, upper rim 5 of bucket 6 is able to penetrate at least partly between the two layers 16a, 16b (or between the opposite peripheral regions) of filter bag 15 when filter 1 is fastened as intended on bucket 6. Hereby layer 16a of filter bag 15 directly facing the outside of the bucket is disposed (up to its uppermost peripheral region) underneath bucket rim 5, while upper peripheral portion 19 (see FIG. 8) of the opposite layer 16b of filter bag 15 is able to extend beyond the bucket rim, so that, when bucket 6 is being tipped, the dirty water contained in bucket 6 is able to run very largely without loss from above through inlet opening 2 disposed between the two layers 167a, 16b into filter 1.

Dirt particles and especially microplastic particles and fibers are reliably held back in filter bag 15 during passage of the water through filter bag 15, provided their diameter or length is larger than the mesh width of the filter fabric being used.

Finally, in FIGS. 7-10, it can also be clearly recognized that each fastening tape 12, 13, starting from its free end (in the region of the hook-and-loop fastener), branches in the direction of filter bag 15 into two fastening tape portions 12a, 12b and 13a, 13b respectively, wherein the two fastening tape portions 12a, 12b and 13a, 13b respectively of each fastening tape 12, 13 are positioned on a different limb of a V-shaped notch of filter bag 15 or are continued from there as reinforcing tape 17 for the two layers 16a, 16b of the filter fabric forming filter bag 15. In FIG. 9, it can be clearly recognized that the two branched fastening tape portions 12a, 12b and 13a, 13b respectively of each fastening tape (12, 13) have different lengths.

Finally, FIG. 8 also shows the filtered water W emerging from filter bag 15 at the lower end during tipping of bucket 6.

What is claimed is:

1. A filter (1) for filtering dirty water, with an inlet opening (2) for the dirty water, provided on the upper side for use of the filter (1) as intended, and with a filter element (8), by which the water passing through the filter (1) is filtered, wherein:
the filter element (8) is designed for holding back microplastic particles or fibers having diameters or lengths of 200 μm and
in that the filter (1) has a holding structure (4), with which the filter (1) can be fastened on the upper rim (5) of a bucket (6) having dimensions corresponding to it, in such a way that the filter (1), hanging on the outside of the bucket (6), is able to function as a pouring filter for filtering the dirty water running out of the bucket (6) when the bucket (6) is tipped.

2. The filter (1) of claim 1, wherein the holding structure (4) comprises two holding brackets (3), with which the filter (1) can be hung on the upper rim (5) of the bucket (6).

3. The filter (1) of claim 1, wherein the filter (1) can be hung in the manner of a pendulum on the upper rim (5) of a bucket (6) by appropriate configuration of the holding structure (4), so that, when the bucket (6) is tipped, the filter (1) is able to swing, under its own weight and/or under the additional weight of the water running into the filter (1), away from the bucket (6) in such a way that, despite the tipping of the bucket (6), it at least largely retains its spatial orientation imposed when the bucket (6) is standing upright.

4. The filter (1) of claim 1, wherein at least one stop element (9) is provided on the filter (1), which element, in cooperation with a bucket rim (5) projecting outwardly on the bucket, prevent slipping of the filter (1) when the bucket (6) is being tipped.

5. The filter (1) of claim 1, wherein the filter element (8) overlays at least one cutout in at least one wall bounding an interior space of the filter (1).

6. The filter (1) of claim 1, wherein the holding structure (4) of the filter (1) is formed by at least one fastening tape (12, 13), with which the filter (1) can be fastened in the region of the upper rim (5) of the bucket (6), in particular by the fact that the at least one fastening tape (12, 13) encircles the upper rim (5) of the bucket and (6) is suitably fixed there.

7. The filter (1) of claim 6, wherein the at least one fastening tape (12, 13) has a a hook-and-loop fastener (14).

8. The filter (1) of claim 6, wherein the at least one fastening tape (23, 13) and/or the hook-and-loop fastener (14) is dimensioned and/or disposed in such a way that the filter (1) is suitable, within given limits, for fastening on buckets (6) of various sizes and/or on buckets (6) with different cross-sectional geometry.

9. The filter (1) of claim 6, wherein the filter (1) has a filter bag (15) equipped with the inlet opening (2) for the water to be filtered.

10. The filter (1) of claim 9, wherein the filter bag (1) is made from two layers (16a, 16b) joined to one another peripherally, especially stitched to one another by means of reinforcing tapes (17), of which at least on first layer (16a, 16b) functions at least in some regions as a filter element (8).

11. The filter (1) of claim 9, wherein the filter bag (15) has a notch (18) that is V-shaped or can be spread apart in V-shaped manner in the region of the inlet opening (2) on two opposite sides, in which notch the rim (5) of the bucket (6) is able to penetrate at least partly when the filter (1) is fastened as intended on a bucket (6).

12. The filter (1) of claim 9, wherein all rim regions of the filter bag (15) are reinforced with reinforcing tapes (17).

13. The filter (1) of claim 6, wherein two fastening tapes (12, 13) are provided, each of which is branched into a first and second fastening tape portion (12a, 12b; 13a, 13b), wherein the two fastening tape portions (12a, 12b; 13a, 13b) of each fastening tape (12, 13) are positioned on different limbs of the V-shaped notch (18) of the filter bag (15).

14. The filter (1) of claim 13, wherein the two branched fastening tape portions (12a, 12b; 13a, 13b) of each fastening tape (12, 13) have different lengths.

15. The filter (1) of claim 1, wherein the entire filter (1) including filter element (8) and holding structure (4) is made from a single material, especially from a polyamide.

16. The filter (1) of claim 1, wherein the filter element (9) is formed by a filter fabric, especially a thermoset plastic screen fabric, having a mean mesh width of 5 μm-200 μm, preferably of 20-100 μm.

17. A kit comprising a bucket (6) and a filter (1) fastened thereon according to claim 1.
